(19) United States
(12) Patent Application Publication
(10) Pub. No.: US 2009/0231327 A1
(43) Pub. Date: Sep. 17, 2009

(54) METHOD FOR VISUALIZATION OF POINT CLOUD DATA

(75) Inventors: Kathleen Minear, Palm Bay, FL (US); Steven G. Blask, Melbourne, FL (US); Katie Gluvna, Palm Bay, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: Harris Corporation, Melbourne, FL (US)

(21) Appl. No.: 12/046,880

(22) Filed: Mar. 12, 2008

(51) Int. Cl. G06T 15/00

(52) U.S. Cl. 345/419

(57) ABSTRACT

Method for providing a color representation of three-dimensional range data (200) for improved visualization and interpretation. The method also includes selectively determining respective values of the hue (402), saturation (404), and intensity (406) in accordance with a color map (FIG. 5, 6) for mapping the hue, saturation, and intensity to an altitude coordinate of the three-dimensional range data. The color map is defined so that values for the saturation and the intensity have a first peak value at a first predetermined altitude approximately corresponding to an upper height limit (308) of a predetermined target height range (306). Values defined for the saturation and the intensity have a second peak at a second predetermined altitude (310) corresponding to an approximate anticipated height of tree tops within a natural scene.

### BACKGROUND OF THE INVENTION

1. Statement of the Technical Field

The inventive arrangements concern techniques to enhance visualization of point cloud data, and more particularly for visualization of target elements residing within natural scenes.

2. Description of the Related Art

One problem that frequently arises with imaging systems is that targets may be partially obscured by other objects which prevent the sensor from properly illuminating and imaging the target. For example, in the case of a conventional optical type imaging system, targets can be occluded by foliage or camouflage netting, thereby limiting the ability of a system to properly image the target. Still, it will be appreciated that objects that occlude a target are often somewhat porous. Foliage and camouflage netting are good examples of such porous occluders because they often include some openings through which light can pass.

It is known in the art that objects hidden behind porous occluders can be detected and recognized with the use of proper techniques. It will be appreciated that any instantaneous view of a target through an occluder will include only a fraction of the target's surface. This fractional area will be comprised of the fragments of the target which are visible through the porous areas of the occluder. The fragments of the target that are visible through such porous areas will vary depending on the particular location of the imaging sensor. However, by collecting data from several different sensor locations, an aggregation of data can be obtained. In many cases, the aggregation of the data can then be analyzed to reconstruct a recognizable image of the target. Usually this involves a registration process by which a sequence of image frames for a specific target taken from different sensor poses are corrected so that a single composite image can be constructed from the sequence. The registration process aligns 3D point clouds from multiple scenes (frames) so that the observable fragments of the target represented by the 3D point cloud are combined together into a useful image

In order to reconstruct an image of an occluded object, it is known to utilize a three-dimensional (3D) type sensing system. One example of a 3D type sensing system is a Light Detection And Ranging (LIDAR) system. LIDAR type 3D sensing systems generate image data by recording multiple range echoes from a single pulse of laser light to generate an image frame. Accordingly, each image frame of LIDAR data will be comprised of a collection of points in three dimensions (3D point cloud) which correspond to the multiple range echoes within sensor aperture. These points are sometimes referred to as “voxels” which represent a value on a regular grid in three dimensional space. Voxels used in 3D imaging are analogous to pixels used in the context of 2D imaging devices. These frames can be processed to reconstruct an image of a target as described above. In this regard, it should be understood that each point in the 3D point cloud has an individual x, y and z value, representing the actual surface within the scene in 3D.

Notwithstanding the many advantages associated with 3D type sensing systems as described herein, the resulting point-cloud data can be difficult to interpret. To the human eye, the raw point cloud data can appear as an amorphous and uninformative collection of points on a three-dimensional coordinate system. Color maps have been used to help visualize point cloud data. For example, a color map can be used to selectively vary a color of each point in a 3D point cloud in accordance with a predefined variable, such as altitude. In such systems, variations in color are used to signify points at different heights or altitudes above ground level. Notwithstanding the use of such conventional color maps, 3D point cloud data has remained difficult to interpret.

### SUMMARY OF THE INVENTION

The invention concerns a method for providing a color representation of three-dimensional range data for improved visualization and interpretation. The method includes displaying a set of data points including the three-dimensional range data using a color space defined by hue, saturation, and intensity. The method also includes selectively determining respective values of the hue, saturation, and intensity in accordance with a color map for mapping the hue, saturation, and intensity to an altitude coordinate of the three-dimensional range data. The color map is defined so that values for the saturation and the intensity have a first peak value at a first predetermined altitude approximately corresponding to an upper height limit of a predetermined target height range. According to one aspect of the invention, the color map is selected so that values defined for the saturation and the intensity have a second peak value at a second predetermined altitude corresponding to an approximate anticipated height of tree tops within a scene.

The color map can be selected to have a larger value variation in at least one of the hue, saturation, and intensity for each incremental change of altitude within a first range of altitudes in the predetermined target height range as compared to a second range of altitudes outside of the predetermined target height range. For example, the color map can be selected so that at least one of the saturation and the intensity vary in accordance with a non-monotonic function over a predetermined range of altitudes extending above the predetermined target height range. The method can include selecting the non-monotonic function to be a periodic function. For example, the non-monotonic function can be chosen to be a sinusoidal function.

The method can further include selecting the color map to provide the hue, saturation, and intensity to produce a brown hue at a ground level approximately corresponding with a surface of a terrain within a scene, a yellow hue at an upper height limit of a target height range, and a green hue at the second predetermined altitude corresponding to an approximate anticipated height of tree tops within the scene. The method can further include selecting the color map to provide a continuous transition that varies incrementally with altitude, from the brown hue, to the yellow hue, and to the green hue at altitudes between the ground level and the second predetermined altitude.

The method also includes dividing a volume defined by the three dimensional range data of the 3D point cloud into a plurality of sub-volumes, each aligned with a defined portion of the surface of the terrain. The three dimensional range data is used to define the ground level for each of the plurality of sub-volumes.

### BRIEF DESCRIPTION OF THE DRAWINGS

FIG. 1 is a drawing that is useful for understanding how 3D point cloud data is collected by one or more sensors.

FIG. 2 shows an example of a frame containing point cloud data.

FIG. 3. is a drawing that is useful for understanding certain defined altitude or elevation levels contained within a natural scene containing a target.

FIG. 4 is a set of normalized curves showing hue, saturation, and intensity plotted relative to altitude in meters.

FIG. 5A shows a portion of the color map of FIG. 4 plotted on a larger scale.

FIG. 5B shows a portion of the color map of FIG. 4 plotted on a larger scale.

FIG. 6 shows is an alternative representation of the color map in FIG. 4 with descriptions of the variations in hue relative to altitude.

FIG. 7 illustrates how a frame containing a volume of 3D point cloud data can be divided into a plurality of sub-volumes.

FIG. 8 is a drawing that illustrates how each sub-volume of 3D point cloud data can be further divided into a plurality of voxels.

### DETAILED DESCRIPTION OF THE PREFERRED EMBODIMENTS

The invention will now be described more fully hereinafter with reference to accompanying drawings, in which illustrative embodiments of the invention are shown. This invention, may however, be embodied in many different forms and should not be construed as limited to the embodiments set forth herein. For example, the present invention can be embodied as a method, a data processing system, or a computer program product. Accordingly, the present invention can take the form as an entirely hardware embodiment, an entirely software embodiment, or a hardware/software embodiment.

A 3D imaging system generates one or more frames of 3D point cloud data. One example of such a 3D imaging system is a conventional LIDAR imaging system. In general, such LIDAR systems use a high-energy laser, optical detector, and timing circuitry to determine the distance to a target. In a conventional LIDAR system one or more laser pulses is used to illuminate a scene. Each pulse triggers a timing circuit that operates in conjunction with the detector array. In general, the system measures the time for each pixel of a pulse of light to transit a round-trip path from the laser to the target and back to the detector array. The reflected light from a target is detected in the detector array and its round-trip travel time is measured to determine the distance to a point on the target. The calculated range or distance information is obtained for a multitude of points comprising the target, thereby creating a 3D point cloud. The 3D point cloud can be used to render the 3-D shape of an object.

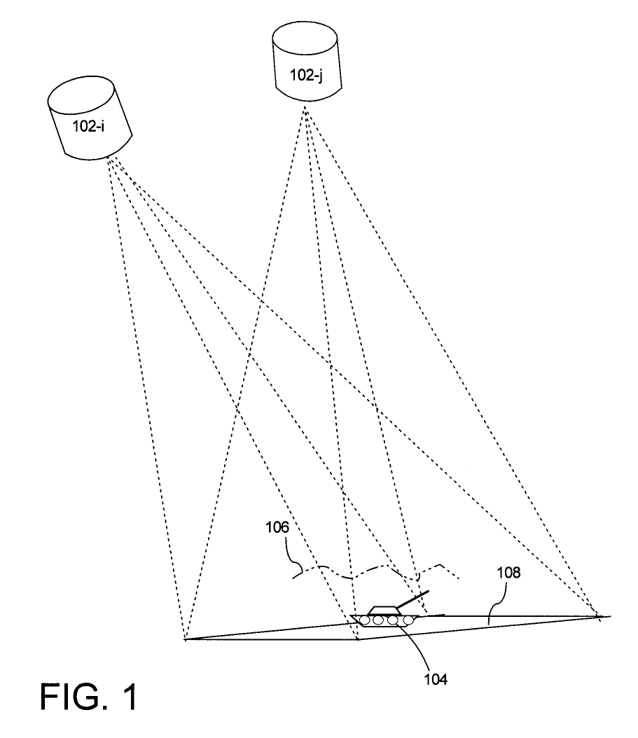

In FIG. 1, the physical volume 108 which is imaged by the sensors 102-i, 102-j can contain one or more objects or targets 104, such as a vehicle. For purposes of the present invention, the physical volume 108 can be understood to be a geographic location on the surface of the earth. For example, the geographic location can be a portion of a jungle or forested area having trees. Consequently, the line of sight between a sensor 102-i, 102-j and a target may be partly obscured by occluding materials 106. The occluding materials can include any type of material that limits the ability of the sensor to acquire 3D point cloud data for the target of interest. In the case of a LIDAR system, the occluding material can be natural materials, such as foliage from trees, or man made materials, such as camouflage netting.

It should be appreciated that in many instances, the occluding material 106 will be somewhat porous in nature. Consequently, the sensors 102-i, 102-j will be able to detect fragments of the target which are visible through the porous areas of the occluding material. The fragments of the target that are visible through such porous areas will vary depending on the particular location of the sensor. By collecting data from several different sensor poses, an aggregation of data can be obtained. Typically, aggregation of the data occurs by means of a registration process. The registration process combines the data from two or more frames by correcting for variations between frames with regard to sensor rotation and position so that the data can be combined in a meaningful way. As will be appreciated by those skilled in the art, there are several different techniques that can be used to register the data. Subsequent to such registration, the aggregated 3D point cloud data from two or more frames can be analyzed in an effort to identify one or more targets.

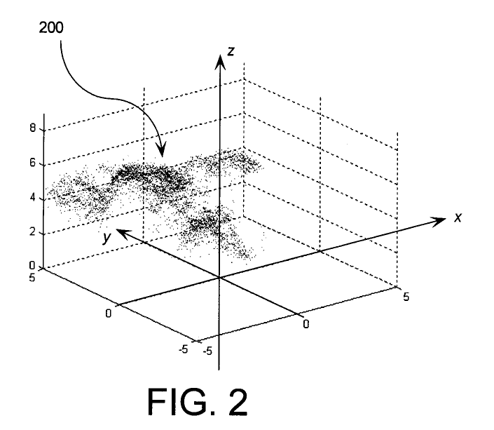

FIG. 2 is an example of a frame containing aggregated 3D point cloud data after completion of registration. The 3D point cloud data is aggregated from two or more frames of such 3D point cloud data obtained by sensors 102-i, 102-j in FIG. 1, and has been registered using a suitable registration process. As such, the 3D point cloud data 200 defines the location of a set of data points in a volume, each of which can be defined in a three-dimensional space by a location on an x, y, and z axis. The measurements performed by the sensor 102-i, 102-j and the subsequent registration process define the x, y, z location of each data point.

3D point cloud data in frame 200 can be color coded for improved visualization. For example, a display color of each point of 3D point cloud data can be selected in accordance with an altitude or z-axis location of each point. In order to determine which specific colors are displayed for points at various z-axis coordinate locations, a color map can be used. For example, in a very simple color map, a red color could be used for all points located at a height of less than 3 meters, a green color could be used for all points located a heights between 3 meters and 5 meters, and a blue color could be used for all points located above 5 meters. A more detailed color map could use a wider range of colors which vary in accordance with smaller increments along the z axis. Color maps are known in the art and therefore will not be described here in detail.

The use of a color map can be of some help in visualizing structure that is represented by 3D point cloud data. However, conventional color maps are not very effective for purposes of improving such visualization. It is believed that the limited effectiveness of such conventional color maps can be attributed in part to the color space conventionally used to define the color map. For example, if a color space is selected that is based on red, green and blue (RGB color space), then a wide range of colors can be displayed. The RGB color space represents all colors as a mixture of red, green and blue. When combined, these colors can create any color on the spectrum. However, an RGB color space can, by itself, be inadequate for providing a color map that is truly useful for visualization of 3D point cloud data. A color map which is exclusively defined in terms of RGB color space is limited. Although any color can be presented using the RGB color space, such a color map does not provide an effective way to intuitively present color information as a function of altitude.

An improved point cloud visualization method can use a new non-linear color map defined in accordance with hue, saturation and intensity (HSI color space). Hue refers to pure color, saturation refers to the degree or color contrast, and intensity refers to color brightness. Thus, a particular color in HSI color space is uniquely represented by a set of HSI values (h, s, i) called triples. The value of h can normally range from zero to 360° (0°≦h≦360°). The values of s and i normally range from zero to one (0≦s,≦1), (0≦i≦1). For convenience, the value of h as discussed herein shall sometimes be represented as a normalized value which is computed as h/360.

Significantly, HSI color space is modeled on the way that humans perceive color and can therefore be helpful when creating a color map for visualizing 3D point cloud data. It is known in the art that HSI triples can easily be transformed to other colors space definitions such as the well known RGB color space system in which the combination of red, green, and blue “primaries” are used to represent all other colors. Accordingly, colors represented in HSI color space can easily be converted to RGB values for use in an RGB based device. Conversely, colors that are represented in RGB color space can be mathematically transformed to HSI color space. An example of this relationship is set forth in the table below:

| RGB | HSI | Result |
|---|---|---|
| (1, 0, 0) | (0°, 1, 0.5) | Red |
| (0.5, 1, 0.5) | (120°, 1, 0.75) | Green |
| (0, 0, 0.5) | (240°, 1, 0.25) | Blue |

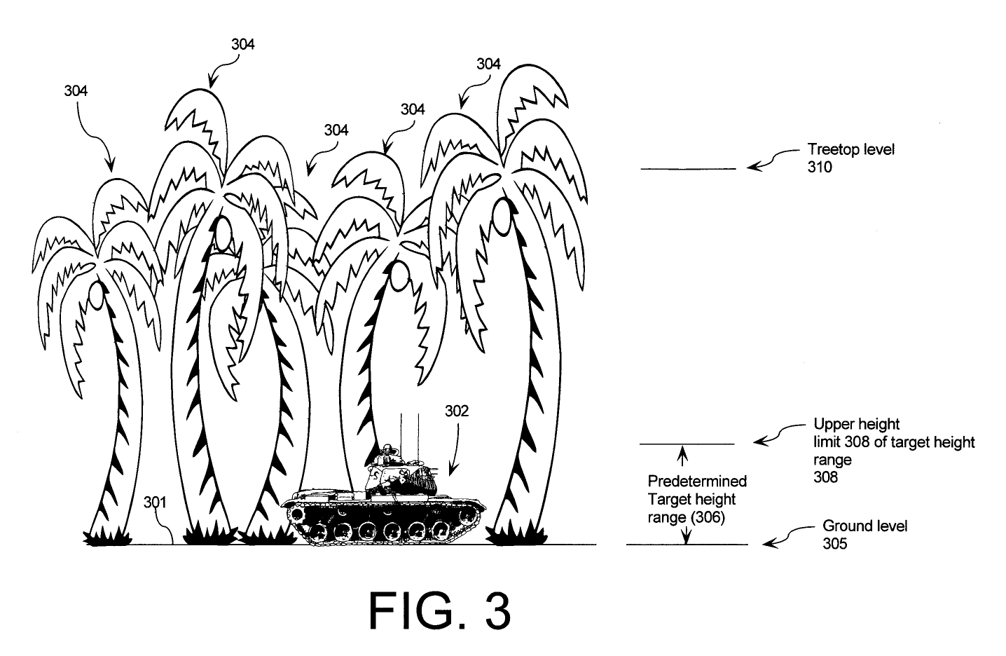

FIG. 3 is a drawing which is helpful for understanding the new non-linear color map. A target 302 is positioned on the ground 301 beneath a canopy of trees 304 which together define a porous occluder. In this scenario, it can be observed that a structure of a ground based military vehicle will generally be present within a predetermined target height range 306. For example, the structure of a target will extend from a ground level 305 to some upper height limit 308. The actual upper height limit will depend on the particular type of vehicle. For the purposes of this invention, it can be assumed that a typical height of a target vehicle will be about 3.5 meters. However, it should be understood that the invention is not limited in this regard. It can be observed that the trees 304 will extend from ground level 305 to a treetop level 310 that is some height above the ground. The actual height of the treetop level 310 will depend upon the type of trees involved. However, an anticipated tree top height can fall within a predictable range within a known geographic area. For example, and without limitation, a tree top height can be approximately 40 meters.

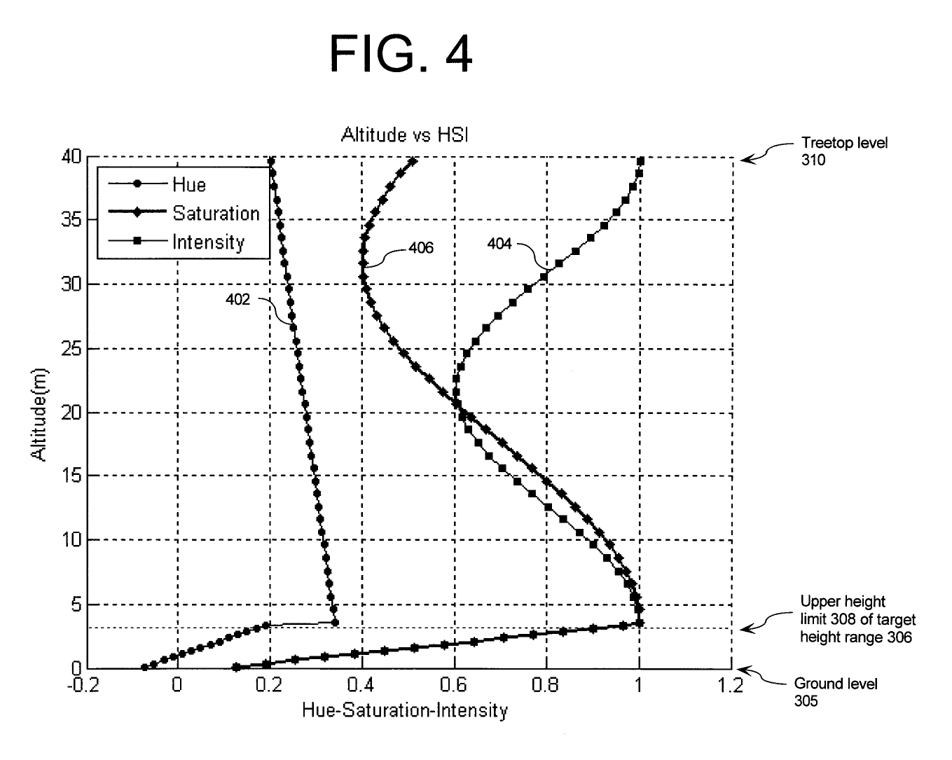

Referring now to FIG. 4, there is a graphical representation of a normalized color map 400 that is useful for understanding the invention. It can be observed that the color map 400 is based on an HSI color space which varies in accordance with altitude or height above ground level. As an aid in understanding the color map 400, various points of reference are provided as previously identified in FIG. 3. For example, the color map 400 shows ground level 305, the upper height limit 308 of target height range 306, and the treetop level 310.

In FIG. 4, it can be observed that the normalized curve for hue 402, saturation 404, and intensity 406 each vary linearly over a predetermined range of values between ground level 305 (altitude zero) and the upper height limit 308 of the target range (about 3.5 meters in this example). The normalized curve for the hue 402 reaches a peak value at the upper height limit 308 and thereafter decreases steadily and in a generally linear manner as altitude increases to tree top level 310.

The normalized curves representing saturation and intensity also have a local peak value at the upper height limit 308 of the target range. However, the normalized curves 404 and 406 for saturation and intensity are non-monotonic, meaning that they do not steadily increase or decrease in value with increasing elevation (altitude). According to an embodiment of the invention, each of these curves can first decrease in value within a predetermined range of altitudes above the target height range 308, and then increases in value. For example, it can be observed in FIG. 4 that there is an inflection point in the normalized saturation curve 404 at approximately 22.5 meters. Similarly, there is an inflection point at approximately 32.5 meters in the normalized intensity curve 406. The transitions and inflections in the non-linear portions of the normalized saturation curve 404, and the normalized intensity curve 406, can be achieved by defining each of these curves as a periodic function, such as a sinusoid. Still, the invention is not limited in this regard. Notably, the normalized saturation curve 404 returns to its peak value at treetop level, which in this case is about 40 meters.

Notably, the peak in the normalized curves 404, 406 for saturation and intensity causes a spotlighting effect when viewing the 3D point cloud data. Stated differently, the data points that are located at the approximate upper height limit of the target height range will have a peak saturation and intensity. The visual effect is much like shining a light on the tops of the target, thereby facilitating identification of the presence and type of target. The second peak in the saturation curve 404 at treetop level has a similar visual effect when viewing the 3D point cloud data. However, in this case, rather than a spotlight effect, the peak in saturation values at treetop level creates a visual effect that is much like that of sunlight shining on the tops of the trees. The intensity curve 406 shows a localized peak as it approaches the treetop level. The combined effect helps greatly in the visualization and interpretation of the 3D point cloud data, giving the data a more natural look.

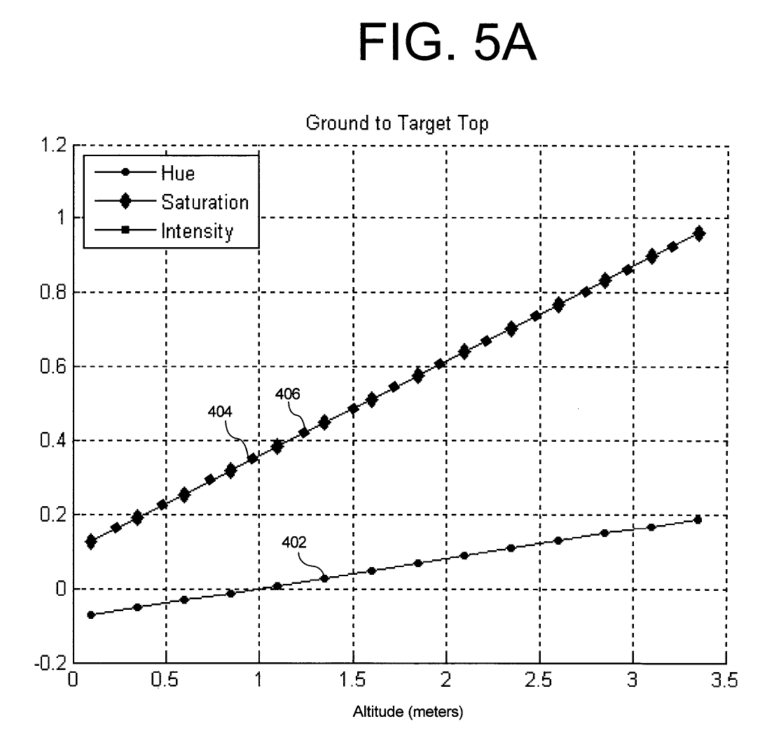

In FIG. 5, the color map coordinates are illustrated in greater detail with altitude shown along the x axis and normalized values of the color map on the y axis. Referring now to FIG. 5A, the linear portions of the normalized curves 402, 404, 406 showing hue, saturation, and intensity are shown on a larger scale for greater clarity. It can be observed in FIG. 5A that the hue and saturation curves are approximately aligned over this range of altitudes corresponding to the target height range.

Referring now to FIG. 5B, the portion of the normalized hue, saturation, and intensity curves 402, 404, 406 for altitudes which exceed the upper height limit 308 of the predetermined target height range 306 are shown in more detail. In FIG. 5B, the peak and inflection points can be clearly observed.

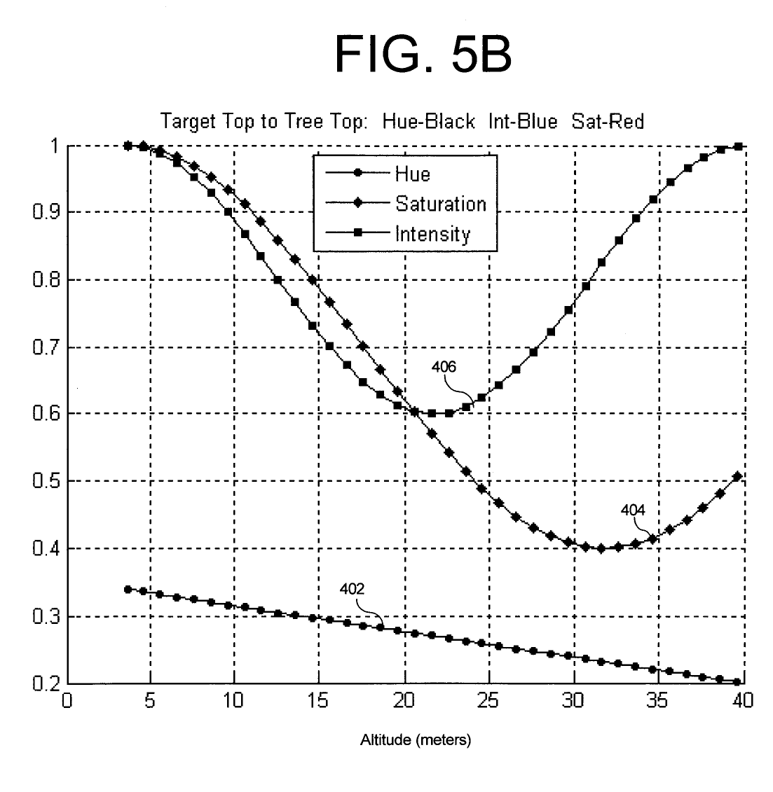

Referring now to FIG. 6, there is shown an alternative representation of a color map that is useful for gaining a more intuitive understanding of the curves shown in FIGS. 4 and 5. FIG. 6 is also useful for understanding why the color map described herein is well suited for visualization of 3D point cloud data representing natural scenes. As used herein, the phrase “natural scenes” generally refers to areas where the targets are occluded primarily by vegetation such as trees.

The relationship between FIG. 4 and FIG. 6 will now be explained in further detail. Recall from FIG. 1 that the target height range 306 extends from the ground level 305 to and upper height limit 308, which in our example is approximately ground plus 3.5 meters. In FIG. 4, the hue values corresponding to this range of altitudes extend from −0.08 (331°) to 0.20 (72°), the saturation and intensity both go from 0.1 to 1. Another way to say this is that the color within the target height range 306 goes from dark brown to yellow. This is not intuitively obvious from the curves shown in FIGS. 4 and 5 because hue is represented as a normalized numerical value. Accordingly, FIG. 6 is valuable for purposes of helping to interpret the information provided in FIGS. 4 and 5.

Referring again to FIG. 6, the data points located at elevations extending from the upper height limit 308 of target height range to the tree-top level 310 goes from hue values of 0.20 (72°) to 0.34 (122.4°), intensity values of 0.6 to 1.0 and saturation values of 0.4 to 1. Another way to say this is that data contained in the upper height limit 308 of the target height range to the tree-top level 310 of the trees areas goes from brightly lit greens, to dimly lit with low saturation greens, and then returns to brightly lit high saturation greens. This is due to the use of sinusoids for the saturation and intensity color map but the use of a linear color map for the hue. Note also that the portion of the color map curves from the ground level 305 to the upper height limit 308 of the target height range 306 uses linear color maps for hue, saturation, and intensity.

The color map in FIG. 6 shows that the hue of point cloud data located closest to the ground will vary rapidly for z axis coordinates corresponding to altitudes from 0 meters to the approximate upper height limit 308 of the target height range. In this example, the upper height limit is about 3.5 meters. However, the invention is not limited in this regard. For example, within this range of altitudes data points can vary in hue (beginning at 0 meters) from a dark brown, to medium brown, to light brown, to tan and then to yellow (at approximately 3.5 meters). For convenience, the hues in FIG. 6 are coarsely represented by the designations dark brown, medium brown, light brown, and yellow. However, it should be understood that the actual color variations used in the color map is considerably more subtle as represented in FIGS. 4 and 5.

Referring again to FIG. 6, dark brown is advantageously selected for point cloud data at the lowest altitudes because it provides an effective visual metaphor for representing soil or earth. Within the color map, hues steadily transition from this dark brown hue to a medium brown, light brown and then tan hue, all of which are useful metaphors for representing rocks and other ground cover. Of course, the actual hue of objects, vegetation or terrain at these altitudes within any natural scene can be other hues. For example the ground can be covered with green grass. However, for purposes of visualizing 3D point cloud data, it is has been found to be useful to generically represent the low altitude (zero to five meters) point cloud data in these hues, with the dark brown hue nearest the surface of the earth.

The color map in FIG. 6 also defines a transition from a tan hue to a yellow hue for point cloud data have a z coordinate corresponding to approximately 3.5 meters in altitude. Recall that 3.5 meters is the approximate upper height limit 308 of the target height range 306. Selecting the color map to transition to yellow at the upper height limit of the target height range has several advantages. In order to appreciate such advantages, it is important to first understand that the point cloud data located approximately at the upper height limit 306 can often form an outline or shape corresponding to a shape of the target vehicle. For example, for target 302 in the shape of a tank, the point cloud data can define the outlines of a gun turret and muzzle.

By selecting the color map in FIG. 6 to display 3D point cloud data in yellow hue at the upper height limit 308, several advantages are achieved. The yellow hue provides a stark contrast with the dark brown hue used for point cloud data at lower altitudes. This aids in human visualization of vehicles by displaying the vehicle outline in sharp contrast to the surface of the terrain. However, another advantage is also obtained. The yellow hue is a useful visual metaphor for sunlight shining on the top of the vehicle. In this regard, it should be recalled that the saturation and intensity curves also show a peak at the upper height limit 308. The visual effect is to create the appearance of intense sunlight highlighting the tops of vehicles. The combination of these features aid greatly in visualization of targets contained within the 3D point cloud data.

Referring once again to FIG. 6, it can be observed that for heights immediately above the upper height limit 308 (approximately 3.5 meters), the hue for point cloud data is defined as a bright green color corresponding to foliage. The bright green color is consistent with the peak saturation and intensity values defined in FIG. 4. As shown in FIG. 4, the saturation and intensity of the bright green hue will decrease from the peak value near the upper height limit 308 (corresponding to 3.5 meters in this example). The saturation curve 40 has a null corresponding to approximately an altitude of about 22 meters. The intensity curve has a null at an altitude corresponding to approximately 32 meters. Finally, the saturation and intensity curves 404, 406 each have a second peak at treetop level 310. Notably, the hue remains green throughout the altitudes above the upper height limit 308. Hence, the visual appearance of the 3D point cloud data above the upper height limit 308 of the target height range 306 appears to vary from a bright green color, to medium green color, dull olive green, and finally a bright lime green color at treetop level 310. The transition in the appearance of the 3D point cloud data for these altitudes will correspond to variations in the saturation and intensity associated with the green hue as defined by the curves shown in FIGS. 4 and 5.

Notably, the second peak in saturation and intensity curves 404, 406 occurs at treetop level 310. As shown in FIG. 6, the hue is a lime green color. The visual effect of this combination is to create the appearance of bright sunlight illuminating the tops of trees within a natural scene. In contrast, the nulls in the saturation and intensity curves 404, 406 will create the visual appearance of shaded understory vegetation and foliage below the treetop level.

In order for the color map to work effectively as described herein, it is advantageous to ensure that ground level 305 is accurately defined in each portion of the scene. This can be particularly important in scenes where the terrain is uneven or varied in elevation. If not accounted for, such variations in the ground level within a scene represented by 3D point cloud data can make visualization of targets difficult. This is particularly true where, as here, the color map is intentionally selected to create a visual metaphor for the content of the scene at various altitudes.

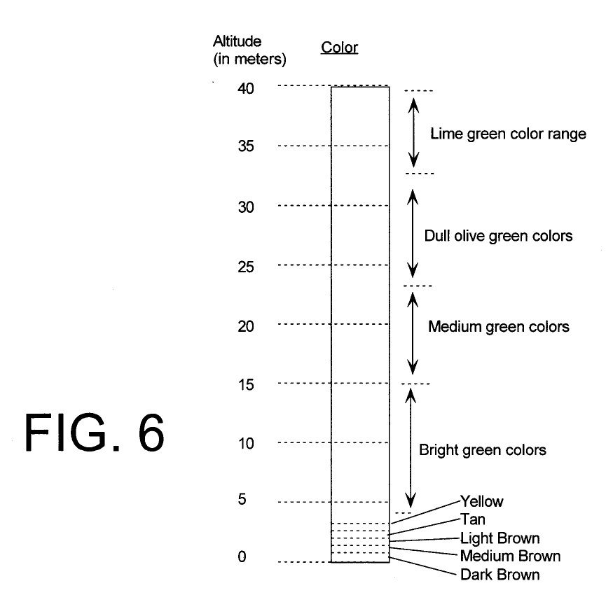

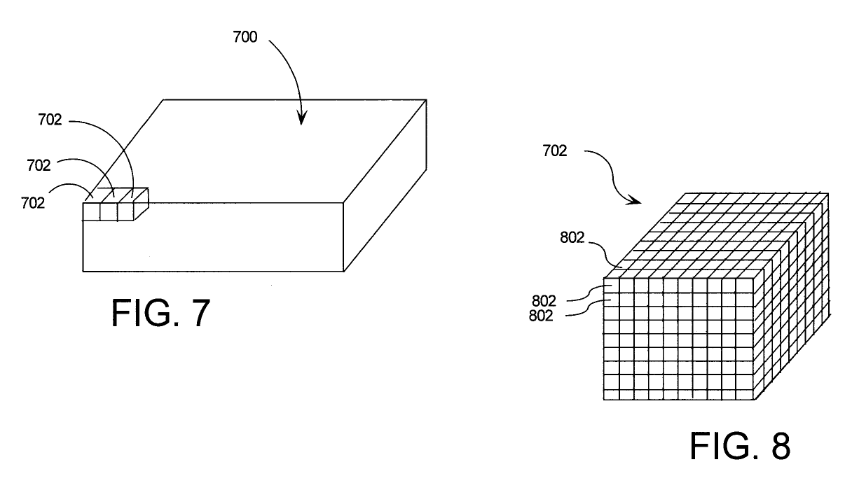

In order to account for variations in terrain elevation, the volume of a scene which is represented by the 3D point cloud data can be advantageously divided into a plurality of sub-volumes. This concept is illustrated in FIGS. 7 and 8. As illustrated therein, each frame 700 of 3D point cloud data is divided into a plurality of sub-volumes 702. This step is best understood with reference to FIG. 7. Individual sub-volumes 702 can be selected that are considerably smaller in total volume as compared to the entire volume represented by each frame of 3D point cloud data. For example, in one embodiment the volume comprising each of frames can be divided into 16 sub-volumes 702. The exact size of each sub-volume 702 can be selected based on the anticipated size of selected objects appearing within the scene. Still, the invention is not limited to any particular size with regard to sub-volumes 702. Referring again to FIG. 8, it can be observed that each sub-volume 702 can be further divided into voxels 802. A voxel is a cube of scene data. For instance, a single voxel can have a size of (0.2 m)³.

Each column of sub-volumes 702 will be aligned with a particular portion of the surface of the terrain represented by the 3D point cloud data. According to an embodiment of the invention, a ground level 305 can be defined for each sub-volume. The ground level can be determined as the lowest altitude 3D point cloud data point within the sub-volume. For example, in the case of a LIDAR type ranging device, this will be the last return received by the ranging device within the sub-volume. By establishing a ground reference level for each sub-volume, it is possible to ensure that the color map will be properly referenced to a true ground level for that portion of the scene.

In light of the foregoing description of the invention, it should be recognized that the present invention can be realized in hardware, software, or a combination of hardware and software. A method in accordance with the inventive arrangements can be realized in a centralized fashion in one processing system, or in a distributed fashion where different elements are spread across several interconnected systems. Any kind of computer system, or other apparatus adapted for carrying out the methods described herein, is suited. A typical combination of hardware and software could be a general purpose computer processor or digital signal processor with a computer program that, when being loaded and executed, controls the computer system such that it carries out the methods described herein.

The present invention can also be embedded in a computer program product, which comprises all the features enabling the implementation of the methods described herein, and which, when loaded in a computer system, is able to carry out these methods. Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Additionally, the description above is intended by way of example only and is not intended to limit the present invention in any way, except as set forth in the following claims.

We claim:

1. A method for providing a color representation of three-dimensional range data for improved visualization and interpretation, comprising:
displaying a plurality of data points comprising said three-dimensional range data using a color space defined by hue, saturation, and intensity;
selectively determining respective values of said hue, saturation, and intensity in accordance with a color map for mapping said hue, saturation, and intensity to an altitude coordinate of said three-dimensional range data;
selecting said color map so that values defined for said saturation and said intensity have a first peak value at a first predetermined altitude approximately corresponding to an upper height limit of a predetermined target height range.

2. The method according to claim 1, further comprising selecting said color map so that values defined for said saturation and said intensity have a second peak value at a second predetermined altitude corresponding to an approximate anticipated height of tree tops within a scene.

3. The method according to claim 1, further comprising defining said color map to have a larger value variation in at least one of said hue, saturation, and intensity for each incremental change of altitude within a first range of altitudes in said predetermined target height range as compared to a second range of altitudes outside of said predetermined target height range.

4. The method according to claim 1, further comprising selecting said color map so that at least one of said saturation and said intensity vary in accordance with a non-monotonic function over a predetermined range of altitudes extending above said predetermined target height range.

5. The method according to claim 4, further comprising selecting said non-monotonic function to be a periodic function.

6. The method according to claim 5, further comprising selecting said non-monotonic function to be a sinusoidal function.

7. The method according to claim 1, further comprising selecting said color map to provide a hue, saturation, and intensity to produce a brown hue at a ground level approximately corresponding with a surface of a terrain within a scene, and a green hue at a second predetermined altitude corresponding to an approximate anticipated height of tree tops within said scene.

8. The method according to claim 7, further comprising selecting said color map to provide a continuous transition from said brown hue to said green hue at altitudes between said ground level and said second predetermined altitude corresponding to said approximate anticipated height of tree tops within said scene.

9. The method according to claim 7, further comprising dividing a volume defined by said three-dimensional range data into a plurality of sub-volumes, each aligned with a defined portion of said surface of said terrain.

10. The method according to claim 9, further comprising using said three dimensional range data to define said ground level for each of said plurality of sub-volumes.

11. The method according to claim 1, further comprising selecting said target height range to extend from ground level to a predetermined height of a known target type.

12. A method for providing a color representation of three-dimensional range data for improved visualization and interpretation, comprising:
displaying a plurality of data points comprising said three-dimensional range data using a color space defined by hue, saturation, and intensity;
selectively determining respective values of said hue, saturation, and intensity in accordance with a color map for mapping said hue, saturation, and intensity to an altitude coordinate of said three-dimensional range data;
selecting said color map so that values defined for said saturation and said intensity have a first peak value at a first predetermined altitude approximately corresponding to an upper height limit of a predetermined target height range; and
selecting said color map so that values defined for said saturation and said intensity have a second peak value at a second predetermined altitude corresponding to an approximate anticipated height of tree tops within a scene.

13. The method according to claim 12, further comprising defining said color map to have a larger value variation in at least one of said hue, saturation, and intensity for each incremental change of altitude within a first range of altitudes in said predetermined target height range as compared to a second range of altitudes outside of said predetermined target height range.

14. The method according to claim 12, further comprising selecting said color map so that at least one of said saturation and said intensity vary in accordance with a non-monotonic function over a predetermined range of altitudes extending above said predetermined target height range.

15. The method according to claim 12, further comprising selecting said color map to provide said hue, saturation, and intensity to produce a brown hue at a ground level approximately corresponding with a surface of a terrain within a scene, and a green hue at said second predetermined altitude corresponding to an approximate anticipated height of tree tops within said scene.

16. The method according to claim 15, further comprising selecting said color map to provide a continuous transition from said brown hue to said green hue at altitudes between said ground level and said second predetermined altitude.

17. The method according to claim 12, further comprising selecting said target height range to extend from ground level to a predetermined height of a known target type.

18. The method according to claim 12, further comprising dividing a volume defined by said three-dimensional range data into a plurality of sub-volumes, each aligned with a defined portion of said surface of said terrain.

19. The method according to claim 18, further comprising using said three dimensional range data to define said ground level for each of said plurality of sub-volumes.

20. A method for providing a color representation of three-dimensional range data for improved visualization and interpretation, comprising:
displaying a plurality of data points comprising said three-dimensional range data using a color space defined by hue, saturation, and intensity;
selectively determining respective values of said hue, saturation, and intensity in accordance with a color map for mapping said hue, saturation, and intensity to an altitude coordinate of said three-dimensional range data;
selecting said color map so that values defined for said saturation and said intensity have a first peak value at a first predetermined altitude approximately corresponding to an upper height limit of a predetermined target height range; and
further comprising defining said color map to have a larger value variation in at least one of said hue, saturation, and intensity for each incremental change of altitude within a first range of altitudes in said predetermined target height range as compared to a second range of altitudes outside of said predetermined target height range.
